(19) United States
(12) Patent Application Publication
(10) Pub. No.: US 2019/0367140 A1
(43) Pub. Date: Dec. 5, 2019

(54) Active Energy Ray Curable Resin Composition for Use Around Water, Anti-Fouling Laminate for Use Around Water, Method for Manufacturing Same, and Product for Use Around Water

(71) Applicant: Dexerials Corporation, Tokyo (JP)

(72) Inventors: Ryo Suzuki, Tokyo (JP); Shinobu Hara, Tokyo (JP); Mikihisa Mizuno, Tokyo (JP); Yukihisa Baba, Tokyo (JP)

(21) Appl. No.: 16/377,692

(22) Filed: Apr. 8, 2019

Related U.S. Application Data
(66) Substitute for application No. 16/149,605, filed on Oct. 2, 2018, now abandoned.

(30) Foreign Application Priority Data
May 29, 2018 (JP) 2018-102082
Feb. 9, 2019 (JP) 2018-021801

(51) Int. Cl. B63B 59/04; B32B 27/30

(52) U.S. Cl. CPC B63B 59/045; B32B 27/30

(57) ABSTRACT

Provided is an anti-fouling laminate for use around water, including a substrate for use around water, and an anti-fouling resin layer disposed on the substrate, wherein the anti-fouling resin layer has a water sliding angle of less than 40°, the anti-fouling resin layer has surface energy of 25 mJ/m² or less, the anti-fouling resin layer is a cured product of an active energy ray curable resin composition, and the active energy ray curable resin composition includes urethane (meth)acrylate in an amount of from 55% by mass through 80% by mass relative to a total amount of monomers in the active energy ray curable resin composition, with the proviso that the urethane (meth)acrylate excludes urethane (meth)acrylate having a structure derived from polysiloxane.

### CROSS-REFERENCE TO RELATED APPLICATIONS

This application claims priority to Japanese Application No. 2018-021801 filed on Feb. 9, 2018 and Japanese Application No. 2018-102082 filed on May 29, 2018, the contents of which are incorporated herein by reference.

### BACKGROUND OF THE INVENTION

### Field of the Invention

The present invention relates to an anti-fouling laminate that can be used around water, a method for manufacturing the same, an active energy ray curable resin composition applicable for formation of an anti-fouling resin layer of the anti-fouling laminate, and a product.

### Description of the Related Art

Scale, soap residues, sebum related stains, and oil-based inks are deposited on a member used around water, such as bathrooms, washrooms, lavatory, kitchens, etc. after repetitive depositions of tap water, soap, sebum, oil stains, such as oil-based inks, and drying of the deposits. When chemicals used around water, such as hair dyes, are deposited on the member, moreover, the member is dyed. It is difficult to remove the above-mentioned stains through typical cleaning and the stains impair appearance of the member and hygiene.

Accordingly, proposed is a technique for imparting an anti-fouling property to a surface of the member for use around water in order to prevent stains on the surface of the member from being remained (see, for example, Japanese Patent Application Laid-Open (JP-A) No. 2012-144695, Japanese Patent (JP-B) No. 6133022, and JP-A Nos. 2016-172923 and 2009-243233).

However, the techniques proposed above have a problem that it is difficult to achieve all of removability of removal of scale, removal of sebum related stains, removal of oil-based inks, and chemical resistance.

### SUMMARY OF THE INVENTION

The present invention aims to solve the above-described various problems existing in the art and achieve the following object. Specifically, the present invention has an object to provide an anti-fouling laminate for use around water exceling in all of removal of scale, removal of sebum related stains, removal of oil-based inks, and chemical resistance, a method for manufacturing the anti-fouling laminate, a product for use around water including the anti-fouling laminate, and an active energy ray curable resin composition for use around water applicable for formation of an anti-fouling resin layer of the anti-fouling laminate.

Means for solving the above-described problems are as follows.
<1>An anti-fouling laminate for use around water, including:

a substrate for use around water; and

an anti-fouling resin layer disposed on the substrate,

wherein the anti-fouling resin layer has a water sliding angle of less than 40°,

the anti-fouling resin layer has surface energy of 25 mJ/m² or less,

the anti-fouling resin layer is a cured product of an active energy ray curable resin composition, and

the active energy ray curable resin composition includes urethane (meth)acrylate in an amount of from 55% by mass through 80% by mass relative to a total amount of monomers in the active energy ray curable resin composition, with the proviso that the urethane (meth)acrylate excludes urethane (meth)acrylate having a structure derived from polysiloxane.
<2> The anti-fouling laminate according to <1>, wherein the anti-fouling resin layer has a hydrophobic molecular structure.
<3> The anti-fouling laminate according to <2>, wherein the hydrophobic molecular structure is a perfluoropolyether structure.
<4> The anti-fouling laminate according to any one of <1> to <3>, wherein the active energy ray curable resin composition includes a hydrophobic monomer having a hydrophobic molecular structure in an amount of from 0.01% by mass to 5.0% by mass relative to a total amount of monomers in the active energy ray curable resin composition.
<5> The anti-fouling laminate according to <4>, wherein the hydrophobic monomer is (meth)acrylate having a perfluoropolyether structure.
<6> The anti-fouling laminate according to any one of <1> to <5>, wherein the anti-fouling resin layer has Martens hardness of 200 N/mm² or more.
<7> The anti-fouling laminate according to any one of <1> to <6>, wherein the anti-fouling resin layer has a coefficient of dynamic friction of 0.40 or less.
<8> The anti-fouling laminate according to any one of <1> to <7>, further including a primer layer disposed between the substrate and the anti-fouling resin layer.
<9> A product for use around water including:

the anti-fouling laminate for use around water according to any one of <1> to <8>.
<10> A method for manufacturing an anti-fouling laminate for use around water, the method including:

irradiating an uncured layer formed of an active energy ray curable resin composition with active energy rays in an atmosphere having an oxygen concentration of less than 1% by volume to form an anti-fouling resin layer, wherein the method for manufacturing an anti-fouling laminate for use around water is a method for manufacturing the anti-fouling laminate for use around water according to any one of <1> to <8>.
<11> An active energy ray curable resin composition for use around water, including: a hydrophobic monomer having a hydrophobic molecular structure, wherein the active energy ray curable resin composition includes urethane (meth)acrylate in an amount of from 55% by mass to 80% by mass relative to a total amount of monomers in the active energy ray curable resin composition with the proviso that the urethane (meth)acrylate excludes urethane (meth)acrylate having a structure derived from polysiloxane, and

an anti-fouling resin layer has a water sliding angle of less than 40° and surface energy of 25 mJ/mm² or less when the active energy ray curable resin composition is cured by irradiating with active energy rays in an atmosphere having an oxygen concentration of less than 1% by volume to produce the anti-fouling resin layer.
<12> The active energy ray curable resin composition according to <11>, wherein the hydrophobic molecular structure is a perfluoropolyether structure.
<13> The active energy ray curable resin composition according to <11> or <12>, wherein the hydrophobic monomer is (meth)acrylate having a perfluoropolyether structure.
<14> The active energy ray curable resin composition according to any one of <11> to <13>,
   wherein the active energy ray curable resin composition includes the hydrophobic monomer in an amount of from 0.01% by mass to 5.0% by mass relative to a total amount of monomers in the active energy ray curable resin composition.

The present invention can solve the above-described various problems existing in the art, achieve the above-mentioned object, and can provide an anti-fouling laminate for use around water exceling in all of removal of scale, removal of sebum related stains, removal of oil-based inks, and chemical resistance, a method for manufacturing the anti-fouling laminate, a product for use around water including the anti-fouling laminate, and an active energy ray curable resin composition for use around water applicable for formation of an anti-fouling resin layer of the anti-fouling laminate.

### BRIEF DESCRIPTION OF THE DRAWINGS

FIG. 1 is a schematic cross-sectional view illustrating one example of an anti-fouling laminate for use around water of the present invention; and

FIG. 2 is a schematic cross-sectional view illustrating another example of the anti-fouling laminate for use around water of the present invention.

### DESCRIPTION OF THE EMBODIMENTS

### (Anti-Fouling Laminate for Use Around Water)

An anti-fouling laminate for use around water of the present invention includes at least a substrate for use around water and an anti-fouling resin layer, and may further include other members, such as a primer layer, according to the necessity.

### <Characteristics of Anti-Fouling Laminate for Use Around Water>

The anti-fouling laminate for use around water has the following characteristics.

The anti-fouling resin layer has a water sliding angle of less than 40°.

The anti-fouling resin layer has surface energy of 25 mJ/m² or less.

The anti-fouling resin layer is a cured product of an active energy ray curable resin composition.

The active energy ray curable resin composition includes urethane (meth)acrylate (with the proviso that the urethane (meth)acrylate excludes urethane (meth)acrylate having a structure derived from polysiloxane) (may be referred to as “urethane (meth)acrylate” hereinafter) in an amount of from 55% by mass to 80% by mass relative to a total amount of monomers in the active energy ray curable resin composition.

When the water sliding angle of the anti-fouling resin layer is small, tap water dripped on a surface of the anti-fouling resin layer slides quickly and drops and therefore a deposition of scales itself can be prevented.

When the surface energy of the anti-fouling resin layer is small, moreover, even if stains are remained on a surface of the anti-fouling resin layer, for example, the stains tend not to be fixed and are easily removed. Accordingly, the stains are easily removed by cleaning using cloth or a sponge used with tap water. When the water sliding angle is small, in addition to the small surface energy, oil-based stains deposited can be removed by applying water with a shower and cleanability is significantly excellent.

In addition to above, moreover, when the anti-fouling resin layer is a cured product of an active energy ray curable resin composition and the active energy ray curable resin composition includes urethane (meth)acrylate includes in an amount of from 55% by mass to 80% by mass relative to a total amount of monomers in the active energy ray curable resin composition, excellent chemical resistance is obtained. For example, the anti-fouling resin layer is not dyed even when hair dye is deposited on a surface of the anti-fouling resin layer. When the active energy ray curable resin composition includes urethane (meth)acrylate includes in an amount of from 55% by mass to 80% by mass relative to a total amount of monomers in the active energy ray curable resin composition, moreover, scratch resistance tends to be improved. When the surface is scratches after repetitive wiping, a dye penetrates from the scratch, the dye cannot be removed with wiping, and therefore chemical resistance degrades. Accordingly, it is preferable that scratch resistance be increased.

Since the anti-fouling laminate for use around water has the above-described characteristics, the anti-fouling laminate excels in all of removal of scale, removal of sebum related stains, removal of oil-based inks, and chemical resistance.

### <Substrate for Use Around Water>

The substrate for use around water is not particularly limited and may be appropriately selected depending on the intended purpose. Examples of the substrate include a resin substrate and an inorganic substrate.

The substrate for use around water is a substrate used around water. A device for use around water, in which the substrate for use around water is used, is a device which has a water supply function, a water draining function, and a water supplying and draining function, and needs to maintain hygiene thereof. Examples of the device include flush toilets, dish washers, washing machines, kitchen sinks, wash basins, washbowls, and bath tubs.

### <<Inorganic Substrate>>

Examples of the inorganic substrate include a metal substrate, a glass substrate, and a ceramic substrate.

Examples of a metal of the metal substrate include copper, a copper alloy, zinc, and steel.

The glass substrate is not particularly limited and may be appropriately selected depending on the intended purpose. Examples of the glass substrate include silica glass (silicate glass), soda-lime glass, and potash glass.

Moreover, the glass substrate may be tempered glass, laminated glass, or heat-resistant glass.

A shape of the glass substrate is typically a plate shape, but the glass substrate may have any shape, such as a sheet shape and a curved shape.

### <<Resin Substrate>>

A material of the resin substrate is not particularly limited and may be appropriately selected depending on the intended purpose. Examples of the material include acrylonitrile-butadiene-styrene (ABS), polycarbonate (PC), polymethyl methacrylate (PMMA), polystyrene (PS), polypropylene (PP), modified polyphenylene ether (m-PPE), and PC/ABS alloys.

A form of the substrate is not particularly limited and may be appropriately selected depending on the intended purpose.

A surface of the substrate for use around water (a surface thereof at the side of the anti-fouling resin layer) may have gloss.

Moreover, a surface of the substrate for use around water may have textures, such as matte finish, hairline finish, spin finish, or diamond-cut finish.

Furthermore, a surface of the substrate for use around water may be plated. Examples of the plating include nickel plating, chrome plating, tin plating, tin alloy plating, zinc plating, copper plating, gold plating, and silver plating. The above-mentioned plated layer may be disposed as a single layer or multiple layers having any combination thereof.

### <Primer Layer>

The primer layer may be disposed between the substrate for use around water and the anti-fouling resin layer in order to improve adhesion between the anti-fouling resin layer and the substrate for use around water.

When the primer layer is thin, an effect of improving adhesion may be insufficient. Therefore, an average thickness of the primer layer is preferably 0.5 μm or more, more preferably from 1 μm to 20 μm, even more preferably from 1 μm to 10 μm, and particularly preferably from 2 μm to 5 μm.

When the average thickness of the primer layer falls within the preferable range, adhesion is unlikely to be reduced even when the primer layer is exposed to high-temperature vapor (e.g., 60° C. or higher), thermal impact (e.g., a significant change from −20° C. to 80° C.), or an alkaline detergent and peeling of the anti-fouling resin layer can be prevented.

The average thickness can be determined by the following method.

A thickness of the primer layer is measured at randomly selected 10 points by means of F20, a film thickness measuring system, available from Filmetrics. An average value of the measured values is determined as an average film thickness.

For example, the primer layer can be formed by applying an active energy ray curable resin composition. Namely, the primer layer is a cured product obtained, for example, by curing an active energy ray curable resin composition with active energy rays. Examples of the active energy ray curable resin composition include an active energy ray curable resin composition that includes at least urethane (meth)acrylate and a photopolymerization initiator and may further include other components, such as a solvent, according to the necessity.

The urethane (meth)acrylate is not particularly limited and may be appropriately selected depending on the intended purpose. Examples of the urethane (meth)acrylate include aliphatic urethane (meth)acrylate and aromatic urethane (meth)acrylate. Among the above-listed examples, aliphatic urethane (meth)acrylate is preferable.

Specific examples of the photopolymerization initiator include specific examples of the photopolymerization initiator listed in the description of the anti-fouling resin layer described later.

Specific examples of the solvent include specific examples of the solvent listed in the description of the anti-fouling resin layer described later.

The active energy ray curable resin composition preferably further includes trifunctional or higher (meth)acrylate. Examples of the trifunctional or higher (meth)acrylate include pentaerythritol tri(meth)acrylate, trimethylolpropane tri(meth)acrylate, trimethylolpropane ethoxytri(meth)acrylate, glycerin ethoxytri(meth)acrylate, glycerin propoxytri(meth)acrylate, isocyanuric acid ethoxytri(meth)acrylate, pentaerythritol tetra(meth)acrylate, pentaerythritol alkoxytetra(meth)acrylate, ditrimethylolpropane tetra(meth)acrylate, and dipentaerythritol hexa(meth)acrylate.

Examples of the alkoxy include ethoxy and propoxy.

A method of the coating is not particularly limited and may be appropriately selected depending on the intended purpose. Examples of the coating include wire bar coating, blade coating, spin coating, reverse roll coating, die coating, spray coating, roll coating, gravure coating, microgravure coating, lip coating, air knife coating, curtain coating, comma coating, and dip coating.

### <Anti-Fouling Resin Layer>

The anti-fouling resin layer has a water sliding angle of less than 40°.

The anti-fouling resin layer has surface energy of 25 mJ/m² or less.

The anti-fouling resin layer preferably has Martens hardness of 200 N/mm² or more.

The anti-fouling resin layer preferably has a coefficient of dynamic friction of 0.40 or less.

The anti-fouling resin layer is a cured product of an active energy ray curable resin composition.

The anti-fouling resin layer preferably has a hydrophobic molecular structure. Examples of the hydrophobic molecular structure include a perfluoropolyether structure. <<Water Sliding Angle>>

The water sliding angle of the anti-fouling resin layer is less than 40°. For example, the water sliding angle thereof is from 5° to 30°, and from 10° to 25°. When the water sliding angle is 40° or more, removal of sebum related stains is insufficient.

The water sliding angle of the anti-fouling resin layer is preferably 30° or less and more preferably 25° or less.

For example, the water sliding angle can be measured by the following method.

The water sliding angle is measured using an automatic contact angle meter DM-501 available from Kyowa Interface Science Co., Ltd. under the following conditions.
Amount of Distilled Water to be Dripped: 20 μL
Measurement Temperature: 25° C.

Water is dripped on a test piece. Five seconds after the dripping, the test piece is continuously tilted to measure an angle with which a droplet starts sliding. The measurement is performed at randomly selected 10 points. An average value of the measured values is determined as a water sliding angle.

### <<Surface Energy>>

The surface energy of the anti-fouling resin layer is 25 mJ/m² or less. For example, the surface energy thereof is from 5 mJ/m² to 20 mJ/m², and from 10 mJ/m² to 20 mJ/m². When the surface energy is more than 25 mJ/m², removal of oil-based inks is insufficient.

The surface energy of the anti-fouling resin layer is preferably 20 mJ/m² or less.

For example, the surface energy can be measured by the following method.

The surface energy is determined by measuring contact angles of water and hexadecane using an automatic contact angle meter DM-501 available from Kyowa Interface Science Co., Ltd. and calculating according to the method of Kaelble-Uy.

### <<<Water Contact Angle>>>

A water contact angle is measured under the following conditions.
Amount of distilled water to be dripped: 2 μL
Measurement temperature: 25° C.

A contact angle 5 seconds after dripping of water is measured at randomly selected 10 points on a test piece, and an average value thereof is determined as a water contact angle. <<<Hexadecane Contact Angle>>>

A hexadecane contact angle is measured under the following conditions.
Amount of Hexadecane to be Dripped: 1 μL
Measurement Temperature: 25° C.

A contact angle 20 seconds after dripping of hexadecane is measured at randomly selected 10 points on a test piece and an average value thereof is determined as a hexadecane contact angle.

The theoretical formula of Kaelble-Uy is a method for quantitatively determining surface energy γ of a solid.

In the theoretical formula of Kaelble-Uy, it is assumed that the surface energy γ is composed of a dispersion component γ^{d} and a polarity component γ^{p}, and total surface energy γ is represented by the following formula (1).

γ=γ^{d}+γ^{p} Formula (1)

When surface energy of a surface of liquid is represented by γ_{L}, surface energy of a solid is represented by γ_{S}, and a contact angle is represented by θ, moreover, the following formula (2) is satisfied.

γ_{L}(1+cos θ)=2√γ_{S}^{d}γ_{L}^{d}+2√γ_{S}^{p}γ_{L}^{p} Formula (2)

Accordingly, γ_{S} is determined by measuring contact angles of two kinds of liquids the γ^{L} components of which are already known, and calculating simultaneous equations associated with γ_{S}^{d} and γ_{S}^{p}.

### <<Martens Hardness>>

Martens hardness of the anti-fouling resin layer is not particularly limited and may be appropriately selected depending on the intended purpose. The Martens hardness thereof is preferably 200 N/mm² or more. For example, the Martens hardness thereof is from 200 N/mm² to 300 N/mm².

For example, the Martens hardness of the anti-fouling resin layer can be measured by the following method.

The Martens hardness of the anti-fouling resin layer of the anti-fouling laminate for use around water can be measured by means of PICODENTOR HM500 available from Fischer Instruments K.K. under the following conditions.
Load: 1 mN/20s
Needle: a diamond pyramid having a face angle of 136°

The measurement is performed at randomly selected 10 points, and an average value of the measured values is determined as Martens hardness.

### <<Coefficient of Dynamic Friction>>

The coefficient of dynamic friction of the anti-fouling resin layer is not particularly limited and may be appropriately selected depending on the intended purpose. The coefficient of dynamic friction thereof is preferably 0.40 or less. For example, the coefficient of dynamic friction thereof is from 0.10 to 0.40, from 0.20 to 0.35, or from 0.25 to 0.30.

For example, the coefficient of dynamic friction of the anti-fouling resin layer can be measured by the following method.

The coefficient of dynamic friction is measured using Triboster TS501 available from Kyowa Interface Science Co., Ltd. BEMCOT (registered trademark) M-3II available from by Asahi Kasei Corporation is adhered to a surface contactor with a piece of double sided tape. The coefficient of dynamic friction is measured 12 times at a measuring load of 50 g/cm², a measuring speed of 1.7 mm/s, and a measuring distance of 20 mm, and the average value thereof is determined as the coefficient of dynamic friction.

When the anti-fouling resin layer has the Martens hardness of 200 N/mm² or more and the coefficient of dynamic friction of 0.40 or less, the anti-fouling resin layer is not easily scratched. Even when cleaning is repetitively performed over a long period, therefore, scratch marks are not easily formed and excellent anti-fouling property and durability can be obtained without changing appearance. As a result, stains associated with hair dyes are unlikely to be fixed as well as obtaining excellent scratch resistance.

### <<Active Energy Ray Curable Resin Composition>>

The anti-fouling resin layer is a cured product of an active energy ray curable resin composition.

The active energy ray curable resin composition includes urethane (meth)acrylate (with the proviso that the urethane (meth)acrylate excludes urethane (meth)acrylate having a structure derived from polysiloxane).

The active energy ray curable resin composition preferably includes a hydrophobic monomer having a hydrophobic molecular structure, and may further include other monomers, a polymerization initiator, and a solvent according to the necessity.

### <<<Urethane (Meth)Acrylate>>>

Examples of the urethane (meth)acrylate include aliphatic urethane (meth)acrylate and aromatic urethane (meth)acrylate.

The urethane (meth)acrylate is free from a structure derived from polysiloxane.

The urethane (meth)acrylate is a material having a urethane bond and a (meth)acryloyl group in one molecule. Such a material can be used as the urethane (meth)acrylate without any limitation.

For example, the urethane (meth)acrylate is obtained through a reaction between a hydroxyl compound having at least one (meth)acryloyl group and isocyanate.

Examples of the isocyanate include polyisocyanate.

For example, the aliphatic urethane (meth)acrylate is obtained through a reaction between a hydroxyl compound having at least one (meth)acryloyl group and aliphatic isocyanate. Examples of the aliphatic isocyanate include aliphatic diisocyanate and aliphatic triisocyanate.

For example, the aromatic urethane (meth)acrylate is obtained through a reaction between a hydroxyl compound having at least one (meth)acryloyl group and aromatic isocyanate. Examples of the aromatic isocyanate include aromatic diisocyanate and aromatic triisocyanate.

An amount of the urethane (meth)acrylate in the active energy ray curable resin composition is from 55% by mass to 80% by mass, and preferably from 55% by mass to 70% by mass, relative to a total amount of monomers in the active energy ray curable resin composition.

### <<<Hydrophobic Monomer>>>

The hydrophobic monomer has a hydrophobic molecular structure. In the present invention, the hydrophobic molecular structure is a structure including a fluorine or silicon. Examples of the hydrophobic molecular structure include a fluoroalkyl structure, a perfluoropolyether structure, and a dimethylsiloxane structure. Among the above-listed example, a perfluoropolyether structure is preferable because the water sliding angle and coefficient of dynamic friction can be made small. Among the hydrophobic monomers, the hydrophobic monomer having a perfluoropolyether structure is preferable in view of that, in addition to that surface energy is low, the water sliding angle and coefficient of dynamic friction can be made small because a molecular chain thereof is flexible and easily moved.

Note that, urethane (meth)acrylate having a structure derived from polysiloxane belongs to the hydrophobic monomer between the urethane (meth)acrylate and the hydrophobic monomer.

Moreover, the hydrophobic monomer is, for example, (meth)acrylate. Specifically, the hydrophobic monomer is, for example, (meth)acrylate having a hydrophobic molecular structure.

The hydrophobic monomer is preferably (meth)acrylate including a perfluoropolyether group and is preferably a compound including, as a perfluoropolyether group, a repeating structure of —(O—CF₂CF₂)—, —(O—CF₂CF₂CF₂)—, or —(O—CF₂C(CF₃)F)—. Examples of commercial products of the hydrophobic monomer include DAC-HP available from DAIKIN INDUSTRIES, LTD., FLUOROLINK AD1700 o available from Solvay Specialty Polymers Japan K.K., FLUOROLINK MD700 available from Solvay Specialty Polymers Japan K.K., CN4000 available from Sartomer, and KY-1203 available from Shin-Etsu Chemical Co., Ltd.

An amount of the hydrophobic monomer in the active energy ray curable resin composition is not particularly limited and may be appropriately selected depending on the intended purpose. The amount of the hydrophobic monomer is preferably from 0.001% by mass to 10% by mass, more preferably from 0.001% by mass to 5.0% by mass, and particularly preferably from 0.01% by mass to 5.0% by mass, relative to a total amount of monomers in the active energy ray curable resin composition. When the amount is less than 0.001% by mass, it may be difficult to make a water sliding angle and surface energy small and it is also difficult to make a coefficient of dynamic friction small. As the amount increases, an anti-fouling property and durability improve. However, the improvement thereof reaches a peak at a certain point and therefore the hydrophobic monomer does not need to be included in an amount exceeding the above-mentioned point. When the amount thereof is more than 5.0% by mass, however, whitening of the anti-fouling resin layer tends to occur to impair the appearance of the anti-fouling laminate, or Martens hardness falls outside the preferable range and therefore scratches or marks tend to be left after repetitive cleaning and resistance is insufficient.

### <<<Other Monomers>>>

The above-mentioned other monomers are not particularly limited and may be appropriately selected depending on the intended purpose, as long as the above-mentioned other monomers are monomer other than the hydrophobic monomer. The above-mentioned other monomers may be monofunctional monomers or polyfunctional monomers.

Moreover, examples of the above-mentioned other monomers include trifunctional or higher (meth)acrylate. The trifunctional or higher (meth)acrylate is a crosslinking agent and can enhance a crosslinking density of a cured product. Examples of the trifunctional or higher (meth)acrylate include dipentaerythritol hexa(meth)acrylate, trimethylolpropane tri(meth)acrylate, trimethylolpropane ethoxytri(meth)acrylate, glycerin ethoxytri(meth)acrylate, glycerin propoxytri(meth)acrylate, isocyanuric acid ethoxytri(meth)acrylate, pentaerythritol tetra(meth)acrylate, pentaerythritol alkoxytetra(meth)acrylate, ditrimethylolpropane tetra(meth)acrylate, and dipentaerythritol hexa(meth)acrylate.

Examples of the alkoxy include ethoxy and propoxy.

An amount of the trifunctional or higher (meth)acrylate in the active energy ray curable resin composition is not particularly limited and may be appropriately selected depending on the intended purpose. The amount thereof is preferably from 20% by mass to 45% by mass, and more preferably from 30% by mass to 40% by mass, relative to a total amount of monomers in the active energy ray curable resin composition. Note that, the total amount of the monomers in the active energy ray curable resin composition does not exceed 100% by mass.

<<<Photopolymerization Initiator>>>

Examples of the photopolymerization initiator include a photoradical polymerization initiator, a photo-acid generating agent, a bisazide compound, hexamethoxymethylmelamine, and tetramethoxy glycoluril.

The photoradical polymerization initiator is not particularly limited and may be appropriately selected depending on the intended purpose. Examples of the photoradical polymerization initiator include the following compounds.
1-hydroxy-cyclohexyl-phenyl-ketone
2-hydroxy-1-{4-[4-(2-hydroxy-2-methyl-propionyl)-benzyl]phenyl}-2-methyl-propan-1-one
2,2-dimethoxy-1,2-diphenylethan-1-one
2-hydroxy-2-methyl-1-phenyl-propan-1-one
1-[4-(2-hydroxyethoxy)-phenyl]-2-hydroxy-2-methyl-1-propan-1-one
mixture of 2-[2-oxo-2-phenylacetoxyethoxylethyl]oxyphenylacetate and 2-(2-hydroxyethoxy)ethyl oxyphenylacetate
2,4,6-trimethylbenzoyl-diphenyl-phosphine oxide
2-methyl-1-methylthiophenyl) -2-morpholinopropan-1-one
ethanone,1-[9-ethyl-6-(2-methylbenzoyl)-9H-carbazol-3-yl]-,1-(O-acetyloxime)

In view of preventing yellowing caused in the appearance of the laminate, the photopolymerization initiator is preferably from free from a nitrogen atom in constituent elements thereof.

In view of preventing yellowing caused in the appearance of the laminate, on the other hand, the photopolymerization initiator has constituent elements composed of only C, H, and O, or constituent elements composed of only C, H, P, and O.

An amount of the photopolymerization initiator in the active energy ray curable resin composition is not particularly limited and may be appropriately selected depending on the intended purpose. The amount thereof is preferably from 0.1% by mass to 10% by mass, more preferably from 0.1% by mass to 5% by mass, and particularly preferably from 1% by mass to 5% by mass.

### <<<Solvent>>>

The solvent is not particularly limited and may be appropriately selected depending on the intended purpose. Examples of the solvent include organic solvents.

Examples of the organic solvents include aromatic-based solvents, alcohol-based solvents, ester-based solvents, ketone-based solvents, glycol ether-based solvents, glycol ether ester-based solvents, chlorine-based solvents, ether-based solvents, N-methylpyrrolidone, dimethylformamide, dimethylsulfoxide, and dimethylacetamide.

In view of obtaining an anti-fouling resin layer of more excellent appearance, is the solvent is preferably a solvent having a boiling point of 80° C. or higher.

Examples of the solvent having a boiling point of 80° C. or higher include propylene glycol monomethyl ether.

An amount of the solvent in the active energy ray curable resin composition is not particularly limited and may be appropriately selected depending on the intended purpose.

The active energy ray curable resin composition is cured by radiation of active energy rays. The active energy rays are not particularly limited and may be appropriately selected depending on the intended purpose. Examples of the active energy rays include electron beams, UV rays, infrared rays, laser beams, visible rays, ionizing radiation (X rays, α rays, β rays, γ rays, etc.), microwaves, and high-frequency waves.

### <<Average Thickness>>

An average thickness of the anti-fouling resin layer is not particularly limited and may be appropriately selected depending on the intended purpose. The average thickness thereof is preferably 1 μm or more, and more preferably 1 μm or more but 15 μm or less.

The average thickness is measured by the following method.

A thickness of the anti-fouling resin layer is measured using F20, a film thickness measuring system, available from Filmetrics at randomly selected 10 paints. An average value of the measured values is determined as an average film thickness.

One example of the anti-fouling laminate for use around water will be described hereinafter.

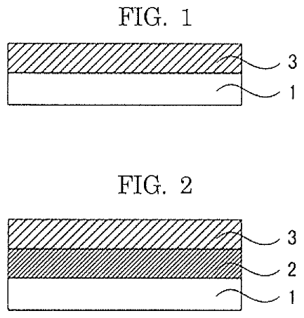

FIG. 1 is a schematic cross-sectional view illustrating one example of the anti-fouling laminate for use around water of the present invention.

The anti-fouling laminate of FIG. 1 includes a substrate for use around water 1 and an anti-fouling resin layer 3.

FIG. 2 is a schematic cross-sectional view illustrating another example of the anti-fouling laminate for use around water of the present invention.

The anti-fouling laminate of FIG. 2 includes a substrate for use around water 1, a primer layer 2, and an anti-fouling resin layer 3.

### (Method for Manufacturing Anti-Fouling Laminate for Use Around Water)

The method for manufacturing an anti-fouling laminate for use around water of the present invention includes at least an anti-fouling resin layer forming step, preferably further includes a primer layer forming step, and may further include other steps according to the necessity.

The method for manufacturing an anti-fouling laminate for use around water is a method for manufacturing the anti-fouling laminate for use around water of the present invention.

### <Primer Layer Forming Step>

The primer layer forming step is not particularly limited and may be appropriately selected depending on the intended purpose, as long as the primer layer forming step is a step for forming the primer layer. Examples of the primer layer forming step include a step including applying an active energy ray curable resin composition for forming a primer layer onto the substrate for use around water, and irradiating the active energy ray curable resin composition with ultraviolet rays to form the primer layer.

### <Anti-Fouling Resin Layer Forming Step>

The anti-fouling resin layer forming step is not particularly limited and may be appropriately selected depending on the intended purpose, as long as the anti-fouling resin layer forming step is a step including irradiating an uncured layer formed of the active energy ray curable resin composition on the substrate for use around water or the primer layer with active energy rays in an atmosphere having an oxygen concentration of less than 1% by volume to form the anti-fouling resin layer.

When active energy ray irradiation is performed in an atmosphere having an oxygen concentration of less than 1% by volume in the course of formation of the anti-fouling resin layer, curing inhibition of a surface is inhibited and curability is excellent, and as a result, excellent anti-fouling property and durability can be obtained.

Examples of the atmosphere having an oxygen concentration of less than 1% by volume include an inert gas atmosphere, such as a nitrogen atmosphere.

### (Active Energy Ray Curable Resin Composition for Use Around Water)

The active energy ray curable resin composition for use around water of the present invention includes at least a hydrophobic monomer having a hydrophobic molecular structure and urethane (meth)acrylate, and may further include other components, such as other monomers, a polymerization initiator, and a solvent, according to the necessity.

When an anti-fouling resin layer is formed by irradiating and curing the active energy ray curable resin composition for use around water with active energy rays in an atmosphere having an oxygen concentration of less than 1% by volume, the anti-fouling resin layer has a water sliding angle of less than 40° and surface energy of 25 mJ/mm² or less.

The active energy ray curable resin composition for use around water includes the urethane (meth)acrylate in an amount of from 55% by mass to 80% by mass relative to a total amount of monomers in the active energy ray curable resin composition for use around water.

The details of the hydrophobic monomer, the urethane (meth)acrylate, the above-mentioned other monomers, the photopolymerization initiator, and the solvent are identical to the details of the hydrophobic monomer, the urethane (meth)acrylate, the above-mentioned other monomers, the photopolymerization initiator, and the solvent in the description of the anti-fouling resin layer of the anti-fouling laminate for use around water. Moreover, preferable embodiments thereof are also identical to the preferable embodiments thereof in the description of the anti-fouling resin layer of the anti-fouling laminate for use around water.

The details and preferable embodiments of the water sliding angle are identical to the details and preferable embodiments of the water sliding angle of the anti-fouling resin layer of the anti-fouling laminate for use around water of the present invention.

The details and preferable embodiments of the surface energy are identical to the details and preferable embodiments of the surface energy of the anti-fouling resin layer of the anti-fouling laminate for use around water of the present invention.

### (Product for Use Around Water)

The product for use around water of the present invention includes the anti-fouling laminate for use around water of the present invention and may further include other members according to the necessity.

The product for use around water is not particularly limited and may be appropriately selected depending on the intended purpose. The product is preferably a device for use around water, which can exhibit an effect of the anti-fouling laminate for use around water of the present invention. The device for use around water is a device which has a water supply function, a water draining function, and a water supplying and draining function, and needs to maintain hygiene thereof. Examples of the device include flush toilets, dish washers, washing machines, kitchen sinks, wash basins, washbowls, and bath tubs.

The anti-fouling laminate for use around water may be formed on part of a surface of the product for use around water, or on an entire surface of the product for use around water.

### EXAMPLES

Examples of the present invention will be explained hereinafter, but Examples shall not be construed as to limit a scope of the present invention in any way.

### <Average Thickness>

A film thickness of each of the anti-fouling resin layer and the primer layer was measured at randomly selected 10 points by means of F20, a film thickness measuring system, available from Filmetrics. An average value of the measured values was determined as an average film thickness of each layer.

### <Adhesion>

A cross-cut test was performed according to JIS K5400. The number of squares remained without being peeled among 100 squares was counted.

A case where no square was peeled (100 squares remained out of 100 squares) was represented by “100/100” and a case where all of the squares were peeled (not even 1 square was remained out of 100 squares) was represented by “0/100.”

### <Water Sliding Angle>

The water sliding angle was measured using an automatic contact angle meter DM-501 available from Kyowa Interface Science Co., Ltd. under the following conditions.
Amount of distilled water to be dripped: 20 μL
Measurement temperature: 25° C.

Water was dripped on a test piece. Five seconds after the dripping, the test piece was continuously tilted to measure an angle with which a droplet starts sliding. The measurement was performed at randomly selected 10 points. An average value of the measured values was determined as a water sliding angle.

### <Surface Energy>

The surface energy was determined by measuring contact angles of water and hexadecane using an automatic contact angle meter DM-501 available from Kyowa Interface Science Co., Ltd. and calculating according to the method of Kaelble-Uy.

### <<Water Contact Angle>>

A water contact angle was measured under the following conditions.
Amount of distilled water to be dripped: 2 μL
Measurement Temperature: 25° C.

A contact angle 5 seconds after dripping of water was measured at randomly selected 10 points on a test piece, and an average value thereof was determined as a water contact angle.

### <<Hexadecane Contact Angle>>

A hexadecane contact angle was measured under the following conditions.
Amount of hexadecane to be dripped: 1 μL
Measurement temperature: 25° C.

A contact angle 20 seconds after dripping of hexadecane was measured at randomly selected 10 points on a test piece and an average value thereof was determined as a hexadecane contact angle.

### <Martens Hardness>

Martens hardness of a test piece was measured by means of PICODENTOR HM500 available from Fischer Instruments K.K. under the following conditions.
Load: 1 mN/20s
Needle: a diamond pyramid having a face angle of 136°

The measurement was performed at randomly selected 10 points, and an average value of the measured values was determined as Martens hardness.

### <Coefficient of Dynamic Friction>

The coefficient of dynamic friction was measured using Triboster TS501 available from Kyowa Interface Science Co., Ltd. BEMCOT (registered trademark) M-3II available from by Asahi Kasei Corporation was adhered to a surface contactor with a piece of double sided tape. The coefficient of dynamic friction was measured 12 times at a measuring load of 50 g/cm², a measuring speed of 1.7 mm/s, and a measuring distance of 20 mm, and the average value thereof was determined as the coefficient of dynamic friction.

### <Removal of Scale>

Tap water was sprayed on a test piece and the test piece was dried at 50° C. This process was repetitively performed 60 times. Thereafter, the test piece was s wiped with clean cloth. The test pieces was then visually observed and evaluated based on the following evaluation criteria.

### [Evaluation Criteria]

Good: Scale was completely removed without leaving any scratch.
Poor: Scale was remained or scratches were left.

### <Removal of Oil-Based Ink Pen>

A test piece was stained with Sharpie PROFESSIONAL (product name, black oil-based ink pen, available from Newell Rubbermaid). Thereafter, the stain was wiped with a piece of tissue paper (Elleair, available from DAIO PAPER CORPORATION) 10 times in circle motions. The surface of the test piece was visually observed and evaluated based on the following criteria.

### [Evaluation Criteria]

Good: The surface repelled the ink of the pen very well and the stain was removed after wiping 2 times to 5 times.
Fair: The surface repelled the ink of the pen weakly and the stain was removed after 2wiping 6 times to 10 times.
Poor: The surface did not repel the ink of the pen and the stain was remained even after wiping 10 times.

### <Removal of Sebum>

Sebum was pressed against a test piece that was set in an upright position. After applying tap water to the test piece using a pipette, the test piece was visually observed and evaluated based on the following evaluation criteria.

### [Evaluation Criteria]

Good: The sebum was removed.
Poor: The sebum was remained.

### <Scratch Resistance>

A test piece was rubbed with a melamine sponge (Gekiochi-kun, available from LEC, INC.) back and forth 500 times at a load of 300 gf/4cm². Thereafter, the test piece was visually observed and evaluated based on the following evaluation criteria.

### [Evaluation Criteria]

Good: No change
Poor: Scratched

### <Resistance Against Hair Dye>

A test piece was rubbed with a melamine sponge (Gekiochi-kun, available from. LEC, INC.) back and forth 500 times at a load of 300 gf/4cm². Thereafter, Men's Bigen Speedy IIS available from Hoyu Co., Ltd. was applied thereon and was left to stand for 24 hours. After washing the dye off with water, the test piece was wiped with clean cloth, was visually observed, and was evaluated based on the following evaluation criteria.

### [Evaluation Criteria]

Good: No change
Poor: Dyed in color

### Example 1

### <Substrate for Use Around Water>

As a substrate for use around water, a PS plate having surface textures (thickness: 3 mm) (substrate No. A), which was typically used as a door surface material for bathrooms, was used.

### <Formation of Anti-Fouling Resin Layer>

The active energy ray curable resin composition having the following composition was applied onto the substrate for use around water in a manner that an average thickness after drying curing was to be 2 μm. After the application, the active energy ray curable resin composition was dried in an oven of 80° C. for 2 minutes. Then, the active energy ray curable resin composition was irradiated with ultraviolet rays at a radiation dose of 500 mJ/cm² using a metal halide lamp in a nitrogen atmosphere to cure an anti-fouling resin layer, to thereby obtain an anti-fouling laminate.

### Active Energy Ray Curable Resin Composition

OPTOOL DAC-HP (available from DAIKIN INDUSTRIES, LTD.): 0.13 parts by mass
KRM8200 (available from DAICEL-ALLNEX LTD.): 65 parts by mass
A-DPHA (available from Shin-Nakamura Chemical Co., Ltd.): 35 parts by mass
IRGACURE 184 (available from BASF): 3 parts by mass
Propylene glycol monomethyl ether: 200 parts by mass

The above-described evaluations were performed on the produced anti-fouling laminate. The results are presented in Table 1-1.

### Comparative Example 1

The PS plate having surface textures (thickness: 3 mm) (substrate No. A) of a door surface material for bathrooms, which was used in Example 1, was evaluated without forming an anti-fouling resin layer. The results are presented in Table 1-1.

### Example 2

### <Substrate For Use Around Water>

As a substrate for use around water, a nickel chrome-plated ABS plate (thickness: 3 mm) (substrate No. B), which was typically used for faucet parts, was used.

### <Formation of Primer Layer>

A primer layer was disposed between a substrate for use around water and an anti-fouling resin layer in order to enhance adhesion with the anti-fouling resin layer. Specifically, the primer layer was disposed by the following method.

The active energy ray curable resin composition having the following composition was applied onto the substrate for use around water in a manner that an average thickness after drying curing was to be 2 μm. After the application, the active energy ray curable resin composition was dried in an oven of 80° C. for 2 minutes. Then, the active energy ray curable resin composition was irradiated with ultraviolet rays at a radiation dose of 500 mJ/cm² using a metal halide lamp in the air atmosphere to thereby form a primer layer.

### Active Energy Ray Curable Resin Composition

UT5181 (available from Nippon Synthetic Chemical Industry Co., Ltd.): 65 parts by mass
A-TMM-3L (available from Shin-Nakamura Chemical Co., Ltd.): 35 parts by mass
IRGACURE 184 (available from BASF): 3 parts by mass
Propylene glycol monomethyl ether: 200 parts by mass

### <Formation of Anti-Fouling Resin Layer>

The active energy ray curable resin composition having the following composition was applied onto the primer layer in a manner that an average thickness after drying curing was to be 2 μm. After the application, the active energy ray curable resin composition was dried in an oven of 80° C. for 2 minutes. Then, the active energy ray curable resin composition was irradiated with ultraviolet rays at a radiation dose of 500 mJ/cm² using a metal halide lamp in a nitrogen atmosphere to cure an anti-fouling resin layer, to thereby obtain an anti-fouling laminate.

### Active Energy Ray Curable Resin Composition

OPTOOL DAC-HP (available from DAIKIN INDUSTRIES, LTD.): 0.13 arts by mass
KRM8200 (available from DAICEL-ALLNEX LTD.): 65 parts by mass
A-DPHA (available from Shin-Nakamura Chemical Co., Ltd.): 35 parts by mass
IRGACURE 184 (available from BASF): 3 parts by mass
Propylene glycol monomethyl ether: 200 parts by mass

The above-described evaluations were performed on the produced anti-fouling laminate. The results are presented in Table 1-1.

### Comparative Example 2

The nickel chrome-plated ABS plate (thickness: 3 mm) (substrate No. B) of faucet parts, which was Example 2, was evaluated without forming a primer layer and an anti-fouling resin layer. The results are presented in Table 1-1.

### Example 3

An anti-fouling laminate was obtained in the same manner as in Example 1, except that the substrate for use around water was changed to an ABS plate (thickness: 3 mm) (substrate No. C) used for a toilet seat member.

The above-described evaluations were performed on the produced anti-fouling laminate. The results are presented in Table 1-1.

### Comparative Example 3

A PP plate (thickness: 3 mm) (substrate No. D), which was typically used for a toilet seat member and to which hydrophobic particles were added, was evaluated. The results are presented in Table 1-1.

### Comparative Example 4

Glass (thickness: 5 mm) (substrate No. E), which was coated with diamond-like carbon (DLC) and was used for bathrooms, was evaluated. The results are presented in Table 1-1.

### Example 4

An anti-fouling laminate was obtained in the same manner as in Example 1, except that, in the formation of the anti-fouling resin layer, the active energy ray curable resin composition having the following composition was used.

### Active Energy Ray Curable Resin Composition

OPTOOL DAC-HP (available from DAIKIN INDUSTRIES, LTD.): 0.5 parts by mass
KRM8200 (available from DAICEL-ALLNEX LTD.): 65 parts by mass
A-DPHA (available from Shin-Nakamura Chemical Co., Ltd.): 35 parts by mass
IRGACURE 184 (available from BASF): 3 parts by mass
Propylene glycol monomethyl ether: 200 parts by mass

The above-described evaluations were performed on the produced anti-fouling laminate. The results are presented in Table 1-2.

### Example 5

An anti-fouling laminate was obtained in the same manner as in Example 1, except that, in the formation of the anti-fouling resin layer, the active energy ray curable resin composition having the following composition was used.

### Active Energy Ray Curable Resin Composition

OPTOOL DAC-HP (available from DAIKIN INDUSTRIES, LTD.): 1.5 parts by mass
KRM8200 (available from DAICEL-ALLNEX LTD.): 65 parts by mass
A-DPHA (available from Shin-Nakamura Chemical Co., Ltd.): 35 parts by mass
IRGACURE 184 (available from BASF): 3 parts by mass
Propylene glycol monomethyl ether: 200 parts by mass

The above-described evaluations were performed on the produced anti-fouling laminate. The results are presented in Table 1-2.

### Example 6

An anti-fouling laminate was obtained in the same manner as in Example 1, except that, in the formation of the anti-fouling resin layer, the active energy ray curable resin composition having the following composition was used.

### Active Energy Ray Curable Resin Composition

OPTOOL DAC-HP (available from DAIKIN INDUSTRIES, LTD.): 0.05 parts by mass
KRM8200 (available from DAICEL-ALLNEX LTD.): 65 parts by mass
A-DPHA (available from Shin-Nakamura Chemical Co., Ltd.): 35 parts by mass
IRGACURE 184 (available from BASF): 3 parts by mass
Propylene glycol monomethyl ether: 200 parts by mass

The above-described evaluations were performed on the produced anti-fouling laminate. The results are presented in Table 1-2.

### Example 7

An anti-fouling laminate was obtained in the same manner as in Example 1, except that, in the formation of the anti-fouling resin layer, the active energy ray curable resin composition having the following composition was used, and the active energy ray curable resin composition was applied in a manner that an average thickness after drying and curing was to be 10 μm.

### Active Energy Ray Curable Resin Composition

OPTOOL DAC-HP (available from DAIKIN INDUSTRIES, LTD.): 0.01 parts by mass
KRM8200 (available from DAICEL-ALLNEX LTD.): 65 parts by mass
A-DPHA (available from Shin-Nakamura Chemical Co., Ltd.): 35 parts by mass
IRGACURE 184 (available from BASF): 3 parts by mass
Propylene glycol monomethyl ether: 200 parts by mass

The above-described evaluations were performed on the produced anti-fouling laminate. The results are presented in Table 1-2.

### Example 8

An anti-fouling laminate was obtained in the same manner as in Example 7, except that the average thickness of the anti-fouling resin layer was changed to 5 μm.

The above-described evaluations were performed on the produced anti-fouling laminate. The results are presented in Table 1-2.

### Example 9

An anti-fouling laminate was obtained in the same manner as in Example 1, except that the active energy ray curable resin composition used for the formation of the anti-fouling resin layer was changed to the following active energy ray curable resin composition.

### Active Energy Ray Curable Resin Composition

KY-1203 (available from Shin-Etsu Chemical Co., Ltd.): 0.13 parts by mass
KRM8200 (available from DAICEL-ALLNEX LTD.): 65 parts by mass
A-DPHA (available from Shin-Nakamura Chemical Co., Ltd.): 35 parts by mass
IRGACURE 184 (available from BASF): 3 parts by mass
Propylene glycol monomethyl ether: 200 parts by mass

The above-described evaluations were performed on the produced anti-fouling laminate. The results are presented in Table 1-2.

### Comparative Example 5

An anti-fouling laminate was obtained in the same manner as in Example 1, except that, in the formation of the anti-fouling resin layer, the active energy ray curable resin composition having the following composition was used.

### Active Energy Ray Curable Resin Composition

KRM8200 (available from DAICEL-ALLNEX LTD.): 65 parts by mass
A-DPHA (available from Shin-Nakamura Chemical Co., Ltd.): 35 parts by mass
IRGACURE 184 (available from BASF): 3 parts by mass
Propylene glycol monomethyl ether: 200 parts by mass

The above-described evaluations were performed on the produced anti-fouling laminate. The results are presented in Table 1-3.

### Comparative Example 6

An anti-fouling laminate was obtained in the same manner as in Example 1, to except that, in the formation of the anti-fouling resin layer, ultraviolet ray irradiation was performed in the air atmosphere.

The above-described evaluations were performed on the produced anti-fouling laminate. The results are presented in Table 1-3.

### Example 10

An anti-fouling laminate was obtained in the same manner as in Example 3, except that, in the formation of the anti-fouling resin layer, the active energy ray curable resin composition having the following composition was used.

### Active Energy Ray Curable Resin Composition

KY-1203 (available from Shin-Etsu Chemical Co., Ltd.): 0.10 parts by mass
KRM8200 (available from DAICEL-ALLNEX LTD.): 55 parts by mass
A-DPHA (available from Shin-Nakamura Chemical Co., Ltd.): 45 parts by mass
IRGACURE 184 (available from BASF): 3 parts by mass
Propylene glycol monomethyl ether: 200 parts by mass

The above-described evaluations were performed on the produced anti-fouling laminate. The results are presented in Table 1-3.

### Example 11

An anti-fouling laminate was obtained in the same manner as in Example 3, except that, in the formation of the anti-fouling resin layer, the active energy ray curable resin composition having the following composition was used.

### Active Energy Ray Curable Resin Composition

KY-1203 (available from Shin-Etsu Chemical Co., Ltd.): 0.20 parts by mass
MU9500 (available from Miwon Specialty Chemical): 80 parts by mass
EBECRYL 40 (available from DAICEL-ALLNEX LTD.): 20 parts by mass
IRGACURE 184 (available from BASF): 3 parts by mass
Propylene glycol monomethyl ether: 200 parts by mass

The above-described evaluations were performed on the produced anti-fouling laminate. The results are presented in Table 1-3.

### Example 12

An anti-fouling laminate was obtained in the same manner as in Example 3, except that, in the formation of the anti-fouling resin layer, the active energy ray curable resin composition having the following composition was used.

### Active Energy Ray Curable Resin Composition

KY-1203 (available from Shin-Etsu Chemical Co., Ltd.): 0.10 parts by mass
CN975 (available from Sartomer): 70 parts by mass
A-TMM-3 (available from Shin-Nakamura Chemical Co., Ltd.): 30 parts by mass
IRGACURE 184 (available from BASF): 3 parts by mass
Propylene glycol monomethyl ether: 200 parts by mass

The above-described evaluations were performed on the produced anti-fouling laminate. The results are presented in Table 1-3.

### Comparative Example 7

An anti-fouling laminate was obtained in the same manner as in Example 2, except that, in the formation of the anti-fouling resin layer, the active energy ray curable resin composition having the following composition was used.

### Active Energy Ray Curable Resin Composition

KY-1203 (available from Shin-Etsu Chemical Co., Ltd.): 0.10 parts by mass
EBECRYL 40 (available from DAICEL-ALLNEX LTD.): 20 parts by mass
SR9035 (available from Sartomer): 80 parts by mass
IRGACURE 184 (available from BASF): 3 parts by mass
Propylene glycol monomethyl ether: 200 parts by mass

The above-described evaluations were performed on the produced anti-fouling laminate. The results are presented in Table 1-3.

### Comparative Example 8

An anti-fouling laminate was obtained in the same manner as in Example 1, except that, in the formation of the anti-fouling resin layer, the active energy ray curable resin composition having the following composition was used.

### Active Energy Ray Curable Resin Composition

KY-1203 (available from Shin-Etsu Chemical Co., Ltd.): 0.10 parts by mass
KRM8200 (available from DAICEL-ALLNEX LTD.): 20 parts by mass
SR9035 (available from Sartomer): 80 parts by mass
IRGACURE 184 (available from BASF): 3 parts by mass
Propylene glycol monomethyl ether: 200 parts by mass

The above-described evaluations were performed on the produced anti-fouling laminate. The results are presented in Table 1-3.

TABLE 1-1

| | | | Comp. | | Comp. | | Comp. | Comp. |
|---|---|---|---|---|---|---|---|---|
| | | Ex. 1 | Ex. 1 | Ex. 2 | Ex. 2 | Ex. 3 | Ex. 3 | Ex. 4 |
| Anti-fouling | DAC-HP | 0.13 | — | 0.13 | — | 0.13 | — | — |
| resin layer | KY-1203 | — | | — | | — | | |
| | KRM8200 | 65 | | 65 | | 65 | | |
| | MU9500 | — | | — | | — | | |
| | CN975 | — | | — | | — | | |
| | A-DPHA | 35 | | 35 | | 35 | | |
| | EBECRYL 40 | — | | — | | — | | |
| | A-TMM-3 | — | | — | | — | | |
| | SR9035 | — | | — | | — | | |
| | IRGACURE 184 | 3 | | 3 | | 3 | | |
| | PGME | 200 | | 200 | | 200 | | |
| | Curing atmosphere | Nitrogen | | Nitrogen | | Nitrogen | | |
| | Average thickness | 2 | | 2 | | 2 | | |
| | (μm) | | | | | | | |
| | Amount of | 0.13 | | 0.13 | | 0.13 | | |
| | hydrophobic monomer | | | | | | | |
| | (mass %) | | | | | | | |
| | Amount of urethane | 65 | | 65 | | 65 | | |
| | (meth)acrylate | | | | | | | |
| | (mass %) | | | | | | | |
| Primer layer | Presence of primer | Not | — | Present | — | Not | — | — |
| | layer | Present | | | | present | | |
| | UT5181 | — | | 65 | | — | | |
| | A-TMM-3L | — | | 35 | | — | | |
| | IRGACURE 184 | — | | 3 | | — | | |
| | PGME | — | | 200 | | — | | |
| | Average thickness | — | | 2 | | — | | |
| | (μm) | | | | | | | |
| Substrate for use around | | A | A | B | B | C | D | E |
| water No. | | | | | | | | |
| valuations | Adhesion | 100/100 | — | 100/100 | — | 100/100 | — | — |
| | Water sliding angle (°) | 20 | 64 | 17 | 64 | 17 | 40 | 56 |
| | Surface energy | 13 | 36 | 13 | 44 | 13 | 27 | 38 |
| | (mJ/m²) | | | | | | | |
| | Martens hardness | 250 | 117 | 250 | 5290 | 250 | 56 | 3590 |
| | (N/mm²) | | | | | | | |
| | Coefficient of dynamic | 0.30 | 0.10 | 0.30 | 0.10 | 0.30 | 0.10 | 0.45 |
| | friction | | | | | | | |
| | Removal of scale | Good | Poor | Good | Poor | Good | Poor | Good |
| | Removal of oil-based | Good | Poor | Good | Poor | Good | Poor | Poor |
| | ink pen | | | | | | | |
| | Removal of sebum | Good | Poor | Good | Poor | Good | Poor | Poor |
| | Scratch resistance | Good | Poor | Good | Good | Good | Poor | Good |
| | Hair dye resistance | Good | Poor | Good | Good | Good | Poor | Good |

TABLE 1-2

| | | Ex. 4 | Ex. 5 | Ex. 6 | Ex. 7 | Ex. 8 | Ex. 9 |
|---|---|---|---|---|---|---|---|
| Anti-fouling | DAC-HP | 0.5 | 1.5 | 0.05 | 0.01 | 0.01 | — |
| resin layer | KY-1203 | — | — | — | — | — | 0.13 |
| | KRM8200 | 65 | 65 | 65 | 65 | 65 | 65 |
| | MU9500 | — | — | — | — | — | — |
| | CN975 | — | — | — | — | — | — |
| | A-DPHA | 35 | 35 | 35 | 35 | 35 | 35 |
| | EBECRYL 40 | — | — | — | — | — | — |
| | A-TMM-3 | — | — | — | — | — | — |
| | SR9035 | — | — | — | — | — | — |
| | IRGACURE 184 | 3 | 3 | 3 | 3 | 3 | 3 |
| | PGME | 200 | 200 | 200 | 200 | 200 | 200 |
| | Curing atmosphere | Nitrogen | Nitrogen | Nitrogen | Nitrogen | Nitrogen | Nitrogen |
| | Average thickness (μm) | 2 | 2 | 2 | 10 | 5 | 2 |
| | Amount of hydrophobic | 0.50 | 1.48 | 0.05 | 0.01 | 0.01 | 0.13 |
| | monomer (mass %) | | | | | | |
| | Amount of urethane | 65 | 64 | 65 | 65 | 65 | 65 |
| | (meth)acrylate (mass %) | | | | | | |
| Primer layer | Presence of primer | Not | Not | Not | Not | Not | Not |
| | layer | present | present | present | present | present | present |
| | UT5181 | — | — | — | — | — | — |
| | A-TMM-3L | — | — | — | — | — | — |
| | IRGACURE 184 | — | — | — | — | — | — |
| | PGME | — | — | — | — | — | — |
| | Average thickness (μm) | — | — | — | — | — | — |
| Substrate for use around | | A | A | A | A | A | A |
| water No. | | | | | | | |
| Evaluations | Adhesion | 100/100 | 100/100 | 100/100 | 100/100 | 100/100 | 100/100 |
| | Water sliding angle (°) | 12 | 15 | 23 | 23 | 35 | 15 |
| | Surface energy (mJ/m²) | 13 | 13 | 17 | 17 | 23 | 13 |
| | Martens hardness | 250 | 250 | 250 | 250 | 250 | 250 |
| | (N/mm²) | | | | | | |
| | Coefficient of dynamic | 0.30 | 0.30 | 0.30 | 0.30 | 0.30 | 0.25 |
| | friction | | | | | | |
| | Removal of scale | Good | Good | Good | Good | Good | Good |
| | Removal of oil-based | Good | Good | Good | Good | Fair | Good |
| | ink pen | | | | | | |
| | Removal of sebum | Good | Good | Good | Good | Good | Good |
| | Scratch resistance | Good | Good | Good | Good | Good | Good |
| | Hair dye resistance | Good | Good | Good | Good | Good | Good |

TABLE 1-3

| | | Comp. | Comp. | | | | Comp. | Comp. |
|---|---|---|---|---|---|---|---|---|
| | | Ex. 5 | Ex. 6 | Ex. 10 | Ex. 11 | Ex. 12 | Ex. 7 | Ex. 8 |
| Anti-fouling | DAC-HP | 0 | 0.13 | — | — | — | — | — |
| resin layer | KY-1203 | — | — | 0.1 | 0.2 | 0.1 | 0.1 | 0.1 |
| | KRM8200 | 65 | 65 | 55 | — | — | — | 20 |
| | MU9500 | — | — | — | 80 | — | — | — |
| | CN975 | — | — | — | — | 70 | — | — |
| | A-DPHA | 35 | 35 | 45 | — | — | — | — |
| | EBECRYL 40 | — | — | — | 20 | — | 20 | — |
| | A-TMM-3 | — | — | — | — | 30 | — | — |
| | SR9035 | — | — | — | — | — | 80 | 80 |
| | IRGACURE 184 | 3 | 3 | 3 | 3 | 3 | 3 | 3 |
| | PGME | 200 | 200 | 200 | 200 | 200 | 200 | 200 |
| | Curing atmosphere | Nitrogen | Air | Nitrogen | Nitrogen | Nitrogen | Nitrogen | Nitrogen |
| | Average thickness | 2 | 2 | 2 | 2 | 2 | 2 | 2 |
| | (μm) | | | | | | | |
| | Amount of | 0.00 | 0.13 | 0.10 | 0.20 | 0.10 | 0.10 | 0.10 |
| | hydrophobic monomer | | | | | | | |
| | (mass %) | | | | | | | |
| | Amount of urethane | 65 | 65 | 55 | 80 | 70 | 0 | 20 |
| | (meth)acrylate | | | | | | | |
| | (mass %) | | | | | | | |
| Primer layer | Presence of primer | Not | Not | Not | Not | Not | Present | Not |
| | layer | present | present | present | present | present | | present |
| | UT5181 | — | — | — | — | — | 65 | — |
| | A-TMM-3L | — | — | — | — | — | 35 | — |
| | IRGACURE 184 | — | — | — | — | — | 3 | — |
| | PGME | — | — | — | — | — | 200 | — |
| | Average thickness | — | — | — | — | — | 2 | — |
| | (μm) | | | | | | | |
| Substrate for use around | | A | A | C | C | C | B | A |
| water No. | | | | | | | | |
| Evaluations | Adhesion | 100/100 | 100/100 | 100/100 | 100/100 | 100/100 | 100/100 | 100/100 |
| | Water sliding angle (°) | 40 | 56 | 19 | 19 | 20 | 23 | 25 |
| | Surface energy | 45 | 15 | 13 | 13 | 13 | 13 | 13 |
| | (mJ/m²) | | | | | | | |
| | Martens hardness | 250 | 250 | 260 | 210 | 260 | 20 | 32 |
| | (N/mm²) | | | | | | | |
| | Coefficient of dynamic | 0.71 | 0.30 | 0.26 | 0.23 | 0.23 | 0.23 | 0.23 |
| | friction | | | | | | | |
| | Removal of scale | Good | Good | Good | Good | Good | Good | Good |
| | Removal of oil-based | Poor | Good | Good | Good | Good | Good | Good |
| | ink pen | | | | | | | |
| | Removal of sebum | Poor | Poor | Good | Good | Good | Good | Good |
| | Scratch resistance | Good | Good | Good | Good | Good | Good | Good |
| | Hair dye resistance | Good | Good | Good | Good | Good | Poor | Poor |

In Tables 1-1 to 1-3, the hydrophobic monomer amount (% by mass) is an amount(% by mass) of the hydrophobic monomer in the active energy ray curable resin composition relative to a total amount of monomers in the active energy ray curable resin composition; and the urethane (meth)acrylate amount (% by mass) is an amount (% by mass) of the urethane (meth)acrylate in the active energy ray curable resin composition relative to a total amount of monomers in the active energy ray curable resin composition.

The details of the substrates for use around water are as follows.
Substrate for use around water No. A: PS plate having surface textures (thickness: 3 mm), which is typically used as a door surface material for bathrooms
Substrate for use around water No. B: nickel chrome-plated ABS plate (thickness: 3 mm), which is typically used for faucet parts
Substrate for use around water No. C: ABS plate (thickness: 3 mm) used for a toilet seat member
Substrate for use around water No. D: hydrophobic particles-added PP plate (thickness: 3 mm) used for a toilet seat member
Substrate for use around water No. E: glass (thickness: 5 mm), which is coated with diamond-like carbon (DLC) and is used for bathrooms

The details of the materials in Tables 1-1 to 1-3 are as follows.

### <Materials of Anti-Fouling Resin Layer>

OPTOOL DAC-HP: (meth)acryl group-containing perfluoropolyether (PFPE), available from DAIKIN INDUSTRIES, LTD.
KY-1203: (meth)acryl group-containing perfluoropolyether (PFPE), available from Shin-Etsu Chemical Co., Ltd.
KRM8200: aliphatic urethane acrylate, available from DAICEL-ALLNEX LTD.
MU9500: aliphatic urethane acrylate, available from Miwon Specialty Chemical
CN975: aromatic urethane acrylate, available from Sartomer
A-DPHA: dipentaerythritol hexaacrylate, available from Shin-Nakamura Chemical Co., Ltd.
EBECRYL 40: a tetrafunctional acrylate monomer, available from DAICEL-ALLNEX LTD.
A-TMM-3: a trifunctional acrylate monomer, available from Shin-Nakamura Chemical Co., Ltd.
SR9035: ethoxylated trimethylol propane tri(meth)acrylate, available from Sartomer
IRGACURE 184: 1-hydroxy-cyclohexyl-phenyl-ketone, a photopolymerization initiator, available from BASF
PGME: propylene glycol monomethyl ether

### <Materials of Primer Layer>

UT5181: urethane acrylate, available from Nippon Synthetic Chemical Industry Co., Ltd.
A-TMM-3L: pentaerythritol triacrylate (triester: about 55%), available from Shin-Nakamura Chemical Co., Ltd.
IRGACURE 184: 1-hydroxy-cyclohexyl-phenyl-ketone, a photopolymerization initiator, available from BASF
PGME: propylene glycol monomethyl ether

The anti-fouling laminates of Examples 1 to 12 exceled in all of removal of scale, removal of sebum related stains, removal of oil-based inks, and chemical resistance (resistance against hair dye). Moreover, the anti-fouling laminates of Examples 1 to 12 also had excellent scratch resistance.

Compared to Example 8, in Examples 1 to 7 and 9 to 12, the water sliding angle and surface energy of each anti-fouling resin layer were small, the water sliding angle was 30° or less and the surface energy was 20 mJ/m² or less, and therefore removal of oil-based inks was more excellent than that of Example 8.

In Comparative Examples 1 and 3, on the other hand, all of removal of scale, removal of sebum related stains, removal of oil-based inks, scratch resistance, and chemical resistance (resistance against hair dye) were poor.

In Comparative Example 2, scratch resistance and chemical resistance (resistance against hair dye) were excellent, but removal of scale, removal of sebum related stains, and removal of oil-based inks were poor.

In Comparative Examples 4 and 5, removal of scale, scratch resistance, and chemical resistance (resistance against hair dye) were excellent, but removal of sebum related stains and removal of oil-based inks were poor.

In Comparative Example 6, removal of scale, removal of sebum related stains, scratch resistance, and chemical resistance (resistance against hair dye) were is excellent, but removal of oil-based inks was poor.

In Comparative Examples 7 and 8, removal of scale, removal of sebum related stains, removal of oil-based inks, and scratch resistance were excellent, but chemical resistance (resistance against hair dye) was poor.

### INDUSTRIAL APPLICABILITY

The anti-fouling laminate for use around water of the present invention can be suitably used for devices for use around water (e.g., washrooms, bathrooms, domestic kitchens, lavatory, professional kitchens, and food factories), such as flush toilets, toilet seat members (e.g., toilet seats, lids, nozzles, and nozzle covers), dish washers, washing machines, kitchen sinks, members for kitchen hood, workbenches, wash basins, washbowls, bath tubs themselves, bathtub aprons, window materials, partitions, wall materials, flooring materials, faucet parts, faucets, shower heads, shower bars, hose pipes, racks, holders, handrails, sash-window frames, sash-door frame, drainage fittings, drainages, and mirrors.

What is claimed is:

1. An anti-fouling laminate for use around water, comprising:
a substrate for use around water; and
an anti-fouling resin layer disposed on the substrate,
wherein the anti-fouling resin layer has a water sliding angle of less than 40°,
the anti-fouling resin layer has surface energy of 25 mJ/m² or less,
the anti-fouling resin layer is a cured product of an active energy ray curable resin composition, and
the active energy ray curable resin composition includes urethane (meth)acrylate in an o amount of from 55% by mass through 80% by mass relative to a total amount of monomers in the active energy ray curable resin composition, with the proviso that the urethane (meth)acrylate excludes urethane (meth)acrylate having a structure derived from polysiloxane.

2. The anti-fouling laminate according to claim 1,
wherein the anti-fouling resin layer has a hydrophobic molecular structure.

3. The anti-fouling laminate according to claim 2,
wherein the hydrophobic molecular structure is a perfluoropolyether structure.

4. The anti-fouling laminate according to claim 1,
wherein the active energy ray curable resin composition includes a hydrophobic monomer having a hydrophobic molecular structure in an amount of from 0.01% by mass to 5.0% by mass relative to a total amount of monomers in the active energy ray curable resin composition.

5. The anti-fouling laminate according to claim 4,
wherein the hydrophobic monomer is (meth)acrylate having a perfluoropolyether structure.

6. The anti-fouling laminate according to claim 1,
wherein the anti-fouling resin layer has Martens hardness of 200 N/mm² or more.

7. The anti-fouling laminate according to claim 1,
wherein the anti-fouling resin layer has a coefficient of dynamic friction of 0.40 or less.

8. The anti-fouling laminate according to claim 1, further comprising a primer layer disposed between the substrate and the anti-fouling resin layer.

9. A product for use around water comprising:
the anti-fouling laminate for use around water according to claim 1.

10. A method for manufacturing an anti-fouling laminate for use around water, the method comprising:
irradiating an uncured layer formed of an active energy ray curable resin composition with active energy rays in an atmosphere having an oxygen concentration of less than 1% by volume to form an anti-fouling resin layer,
wherein the method for manufacturing an anti-fouling laminate for use around water is a method for manufacturing the anti-fouling laminate for use around water according to claim 1.

11. An active energy ray curable resin composition for use around water, comprising:
a hydrophobic monomer having a hydrophobic molecular structure,
wherein the active energy ray curable resin composition includes urethane (meth)acrylate in an amount of from 55% by mass to 80% by mass relative to a total amount of monomers in the active energy ray curable resin composition with the proviso that the urethane (meth)acrylate excludes urethane (meth)acrylate having a structure derived from polysiloxane, and
an anti-fouling resin layer has a water sliding angle of less than 40° and surface energy of 25 and/mm² or less when the active energy ray curable resin composition is cured by irradiating with active energy rays in an atmosphere having an oxygen concentration of less than 1% by volume to produce the anti-fouling resin layer.

12. The active energy ray curable resin composition according to claim 11,
wherein the hydrophobic molecular structure is a perfluoropolyether structure.

13. The active energy ray curable resin composition according to claim 11,
wherein the hydrophobic monomer is (meth)acrylate having a perfluoropolyether structure.

14. The active energy ray curable resin composition according to claim 11,
wherein the active energy ray curable resin composition includes the hydrophobic monomer in an amount of from 0.01% by mass to 5.0% by mass relative to a total amount of monomers in the active energy ray curable resin composition.
